(19) United States
(12) Patent Application Publication
(10) Pub. No.: US 2002/0152164 A1
(43) Pub. Date: Oct. 17, 2002

(54) Method and apparatus for processing a check within a financial system

(75) Inventors: Rabindranath Dutta, Austin, TX (US); Dwip N. Banerjee, Austin, TX (US)

Correspondence Address: Duke W. Yee,, Carstens, Yee & Cahoon, LLP, P.O. Box 802334, Dallas, TX, 75380, US

(73) Assignee: International Business Machines Corporation, Armonk, NY

(21) Appl. No.: 09/833,340

(22) Filed: Apr. 12, 2001

(51) Int. Cl. G06F 17/60

(52) U.S. Cl. 705/43; 705/45

(57) ABSTRACT

A method, apparatus, and computer implemented instructions for use in a network data processing system to process a check. A check image is received. Optical character recognition is performed on the check image to generate data. Check clearing processes is performed using the check image and the data. These processes are performed without using a physical check itself.

### CROSS REFERENCE TO RELATED APPLICATIONS

The present invention is related to the following applications: Method and Apparatus for Processing Checks at an Automatic Teller Machine for Electronic Transfer, Ser. No. ______, attorney docket no. AUS920010211US1; Method and Apparatus for Incorporating Scanned Checks into Financial Applications, Ser. No. ______, attorney docket no. AUS920010214US1; Method and Apparatus for Bill Payments at an Automatic Teller Machine, Ser. No. ______, attorney docket no. AUS9200102015US1; and Method and Apparatus for Facilitating Transactions at an Automatic Teller Machine, Ser. No. ______, attorney docket no. AUS920010216US1, filed even date hereof, assigned to the same assignee, and incorporated herein by reference.

### BACKGROUND OF THE INVENTION

1. Technical Field

The present invention relates generally to an improved data processing system and in particular to a method and apparatus for processing checks within a financial system. Still more particularly, the present invention provides a method and apparatus for processing checks using images of the checks in a financial system.

2. Description of Related Art

The Federal Reserve System is comprised of twelve regional reserve banks along with the Board of Governors in Washington, D.C. As the U.S. central bank, the Federal Reserve System formulates monetary policy, regulates bank holding companies and state-chartered member banks, and provides banking services to financial institutions and the U.S. government. Banks interact with the regional reserve banks in various financial transactions.

On a local level, banks have long found that exchanging checks drawn on other banks in their local area could be accomplished very efficiently and cheaply through clearinghouse associations. At this local level, clearinghouse members present and receive checks drawn on one another and agree to rules, operating policies and cost-sharing structures that ensure a common benefit. The National Clearinghouse Association extends the efficiencies and benefits of these local clearinghouses to a national scale by linking them together.

Many of the processes used to transfer funds currently require the handling and transferring of physical checks. This handling requires time and includes inefficiencies. For example, when transferring checks from one financial institution to another financial institution, the checks must be physically moved. This transfer typically requires using some sort of land or airborne carrier service to deliver the checks. Additionally, information on the checks must be identified by the person handling these checks. This information is keyed or entered into each financial institution's data processing system. Further, this information may be required by a clearinghouse or a Federal Reserve Bank. Federal regulations are present, which require checks processed by certain deadlines, such as within the next business day or the next five business days.

Therefore, it would be advantageous to have an improved method and apparatus for reducing the amount of physical handling of checks within a financial system.

### SUMMARY OF THE INVENTION

The present invention provides a method, apparatus, and computer implemented instructions for use in a network data processing system to process a check. A check image is received. Optical character recognition is performed on the check image to generate data. Check clearing processes are performed using the check image and the data. These processes are performed without using a physical check.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a diagram illustrating an automatic teller machine (ATM) in accordance with a preferred embodiment of the present invention;

FIG. 4 is a block diagram illustrating an ATM in accordance with a preferred embodiment of the present invention;

FIG. 5 is a diagram illustrating components used in processing checks in accordance with a preferred embodiment of the present invention;

FIG. 6 is a diagram illustrating a certificate system in accordance with a preferred embodiment of the present invention;

FIG. 7 is a diagram illustrating data flow in creating a check image in accordance with a preferred embodiment of the present invention;

FIG. 8 is a diagram of a smart card, which may be used to create an electronic check, in accordance with a preferred embodiment of the present invention;

FIG. 9 is a diagram of a check presented on a display for completion in accordance with a preferred embodiment of the present invention;

FIG. 10 is a diagram illustrating software components in an ATM in accordance with a preferred embodiment of the present invention;

FIG. 11 is an illustration of a message sent from an ATM to a financial institution in accordance with a preferred embodiment of the present invention;

FIGS. 12A-12B, are a diagram of an electronic check in accordance with a preferred embodiment of the present invention;

FIG. 13 is a a flowchart of a process used for processing a check at an ATM in accordance with a preferred embodiment of the present invention;

FIG. 14 is a flowchart of a process used for creating an electronic check in accordance with a preferred embodiment of the present invention;

FIG. 15 is a flowchart of a process used for processing a check within a financial system in accordance with a preferred embodiment of the present invention; and

FIG. 16 is a diagram illustrating endorsements that may be used by financial institutions during the clearing process of a check in accordance with a preferred embodiment of the present invention.

### DETAILED DESCRIPTION OF THE PREFERRED EMBODIMENT

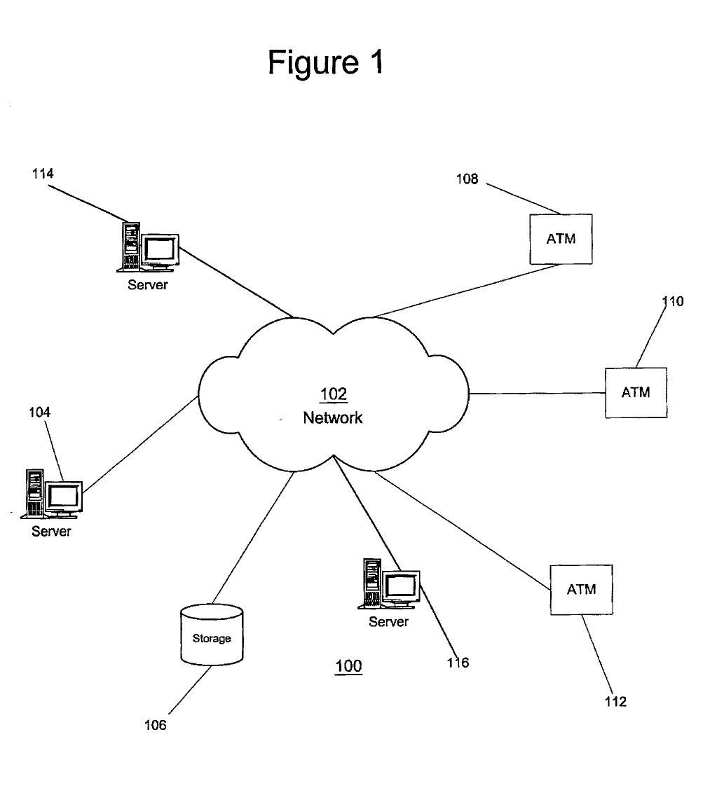

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. Server 104 is a computer located at a financial institution, such as a bank, a credit union, a mortgage company, or a brokerage firm.

Server 104 is used to provide various functions relating to daily financial transactions handled by the bank, such as deposits and withdrawals of funds. In addition, ATMs 108, 110, and 112 also are connected to network 102. ATMs 108, 110, and 112 are clients to server 104. Server 104 is in communication with ATMs 108, 110, and 112 to handle various transactions that users may initiate at these devices. For example, if a user withdraws cash from ATM 108, the debiting of the account is handled by server 104.

Server 114 and server 116 also are connected to network 102 and may represent computers located at other financial institutions. ATMs 108, 110, and 112 also may be clients to these servers depending on the particular user accessing ATMs 108, 110 and 112. Additionally, these servers may also represents computers located at other financial institutions, such as a regional clearing house, a national clearinghouse, or a Federal Reserve Bank.

The present invention provides for scanning of checks at an ATM, such as ATM 108, when a user deposits a check with the financial institution. An image of both sides of the check is made when the check is deposited. As used herein with respect to the present invention, the term “image” refers to a digital or electronic representation of a check as opposed to a paper copy or hard copy of the check. Additionally, optical character recognition is performed on the check to obtain information, such as the recipient of the check, and the amount of funds to be transferred from the account. Further, a magnetic ink reader reads magnetic ink data on the check to obtain information, such as the bank's identification number as well as the user's checking account number with the bank.

A markup language document is created. This document contains other information obtained from the check. The markup language document forms an electronic check in these examples. Additionally, the image of the check also may be associated with the markup language document as part of the electronic check. This electronic check is then sent from ATM 108 to server 104 for processing.

Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

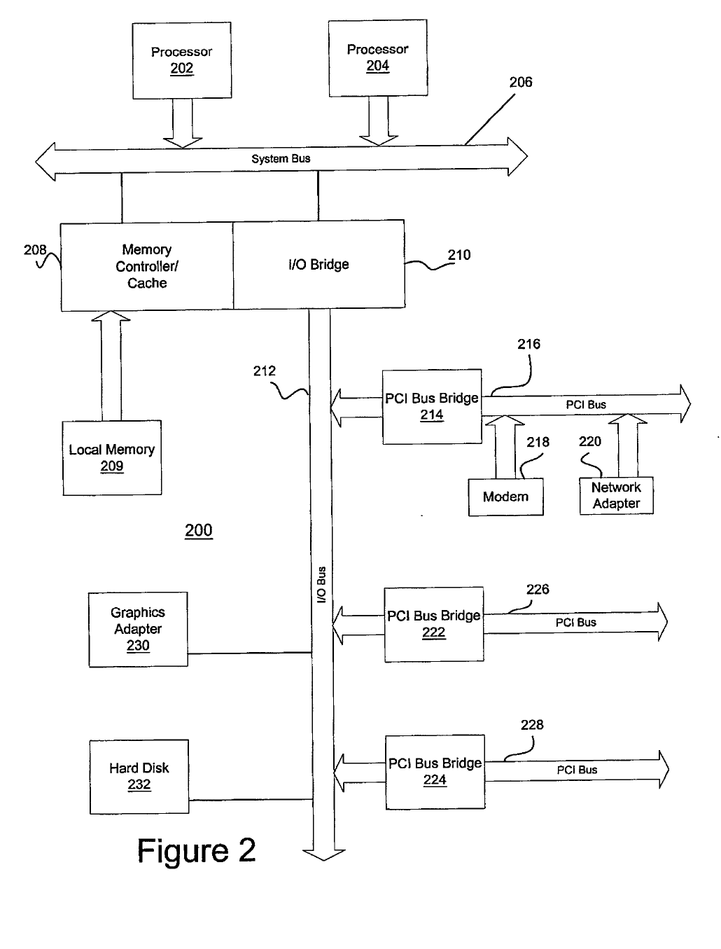

Referring to FIG. 2, a block diagram of a data processing system that may be implemented as a server, such as server 104, 114, or 116 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to ATMs 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system.

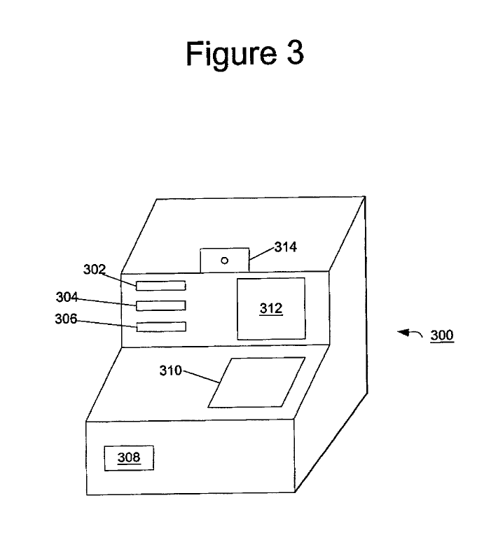

Turning next to FIG. 3, a diagram illustrating an automatic teller machine (ATM) is depicted in accordance with a preferred embodiment of the present invention. ATM 300 is an illustration of an ATM, such as ATM 108, 110 or 112 in FIG. 1.

In this example, an ATM card or a smart card may be received in slot 302. ATM 300 also includes an input slot 304 and an output slot 306. Input slot 304 is used to receive items, such as cash or a check for deposit. Cash dispenser slot 308 is used to dispense cash to a user. Keypad 310 provides an input device for a user to input information, such as an amount of money that is to be deposited or to make selections, such as receiving an account balance or an amount of cash to withdraw. Display 312 is used to present information to the user. Video camera 314 provides for recording transactions.

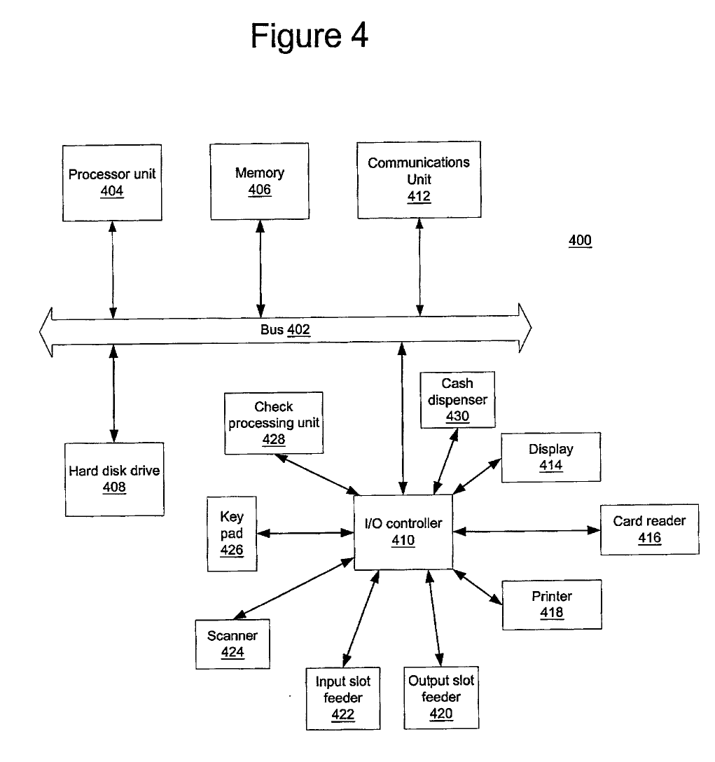

Turning next to FIG. 4, a block diagram illustrating an ATM is depicted in accordance with a preferred embodiment of the present invention. ATM 400 may be implemented as a ATM 108, 110, or 112 in FIG. 1.

In the depicted examples, bus 402 connects processor unit 404, memory 406, hard disk drive 408, I/O controller 410, and communications unit 412. Computer instructions may be located in memory 406 or in hard disk drive 408. These instructions are processed by processor unit 404 to provide ATM functions as well as the check scanning and electronic check creation processes of the present invention. Additionally, transaction information may also be stored on hard disk drive 408. Communications unit 412 establishes a communications link with a server, such as server 104, 114 or 116 in FIG. 1 through a network, such as network 102 in FIG. 1. I/O controller 410 provides a mechanism for input/output devices, such as, for example, display 414, card reader 416, printer 418, output slot feeder 420, input slot feeder 422, scanner 424, keypad 426, check processing unit 428, and cash dispenser 430. Display 414 provides a mechanism to present information to the ATM user. Card reader 416 is used to read an ATM card or a smart card inserted into the ATM. Printer 418 is used to print a receipt or other information in response to a user input. Keypad 426 is used to receive user input.

Output slot feeder 420 is used to feed receipts generated by printer 418 to an output slot, such as output slot 306 in FIG. 3. Input slot reader 422 is used to receive checks or cash placed into an input slot, such as input slot 304 in FIG. 3. Check processing unit 428 is used to move a check within the ATM. In particular, check processing unit 428 may move a check into a position for scanning by scanner 424 and then move the check into storage. If a check in not accepted, the check may be returned to output slot 420 for return to a user. Cash dispenser 430 is used to dispense cash when a user withdrawals funds from a user account.

The components depicted in FIGS. 3 and 4 are provided for purposes of illustration and are not meant to imply architectural limitations to the present invention.

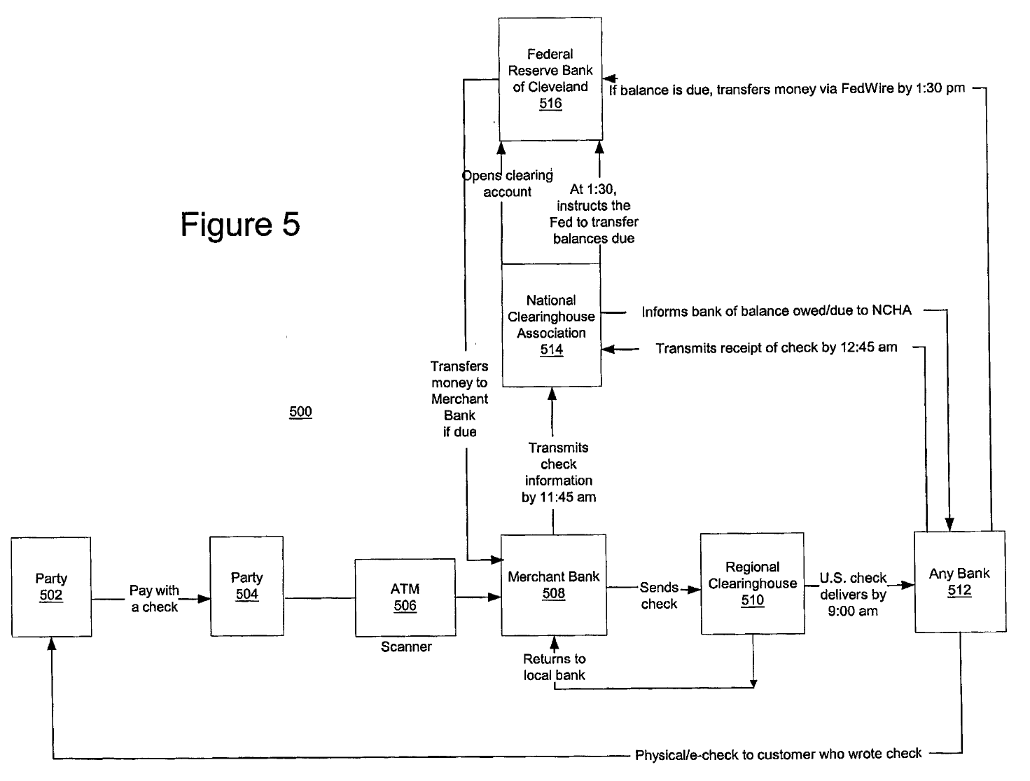

Turning next to FIG. 5, a diagram illustrating components used in processing checks is depicted in accordance with a preferred embodiment of the present invention. Check clearing system 500 is an example of a clearing system, which may incorporate processes of the present invention to handle checks scanned to create a image of the checks. The different components illustrated within check clearing system 500 may be implemented using network data processing system 100 in FIG. 1.

In this example, party 502 may provide payment to party 504 using a physical check. Party 502 is a customer, and party 504 may be a merchant or another customer. Party 504 presents the check at an automatic teller machine (ATM) 506. At this point, the check is scanned to generate an image of the check. In these examples, both the front and back of the check are scanned. Further, optical character recognition (OCR) processes may be initiated to identify information used in routing the check to merchant bank 508. ATM 506 may perform some initial check clearing process, such as for example, verifying a signature or endorsements and crediting or debiting a user's account.

The check is routed to merchant bank 508 electronically without the physical check itself. The physical check remains at ATM 506 and may be collected at a later time for safekeeping or may be returned to party 504 at the conclusion of the ATM transaction. Processing of the check does not require the physical check using the mechanism of the present invention. Merchant bank 508 performs various clearing processes with respect to the image of the check and any information that may have been associated with or transmitted with this image. For example, if the check is written off of merchant bank 508, then this bank will form the necessary processes to debit and credit the account for party 502 and party 504.

If a check is deposited by a customer of merchant bank 508, a credit of this customer's account may be made depending on any rules regarding making funds available from deposited checks. In other words, transactions involving accounts within merchant bank 508 are processed.

The image of the check may have overlay prints or digital signatures added by merchant bank 508 to identify who is clearing what funds and where these clearances occur. The overlay prints are similar to those added to a physical check to identify who has processed the check and what has been done with the check. These overlay prints also may include digital watermarks added by the financial institution. This image is then sent to regional clearing house 510, which removes local transactions, i.e. performs the check settlement and returns the non-local transactions to merchant bank 508. Basically the regional clearinghouse settles the checks for a group of regional banks and returns the rest to merchant bank 508.

Regional clearinghouses such as clearinghouse 510 usually process checks for a group of local banks, such as bank 512. Merchant bank 508 sends check to regional clearinghouse 510. “Remove local transactions”, in these examples, means that a regional clearinghouse, such as, regional clearinghouse 510, is settling checks within the local region (i.e. a check drawn on Bank B, in Houston and submitted by Bank A, in Dallas). Transactions that are non-local are returned to merchant bank 508. For example, these are checks that cannot be settled by the regional clearinghouse.

Other clearing processes identical to those performed with physical checks are performed on digital checks at regional clearinghouse 510. Afterwards, the image of the check is delivered to bank 512. Bank 512 is the bank at which the payor of the check has an account. A copy of the image may then be returned to party 502. This copy may take various forms. For example, the copy may be a copy of the image of the check printed on paper or a copy of the image returned to party 502 electronically. This return of the electronic copy may be made through e-mail in these examples. This process flow illustrates the handling of a check image in place of the physical check.

Additional handling of check information also includes merchant bank 508 transmitting check information obtained from the image to National Clearinghouse Association 514, which may open a clearing account or instruct transfer of balances due to Federal Reserve Bank 516. Further, bank 512 may include interactions with Federal Reserve Bank 516 by transferring funds. Interactions with National Clearinghouse Association 514 and bank 512 may include receiving a message regarding balance owed or due to National Clearinghouse Association 514.

In addition, bank 512 may transmit a message identifying receipt of the check to National Clearinghouse Association 514. By processing an image, rather than the check itself, interactions with Federal Reserve Bank 516 and National Clearinghouse Association 514 are made faster and more efficient up because the transfer of the check and obtaining information from the check through the use of an image of the check eliminates the need for physical handling and allows for quicker transfer of information.

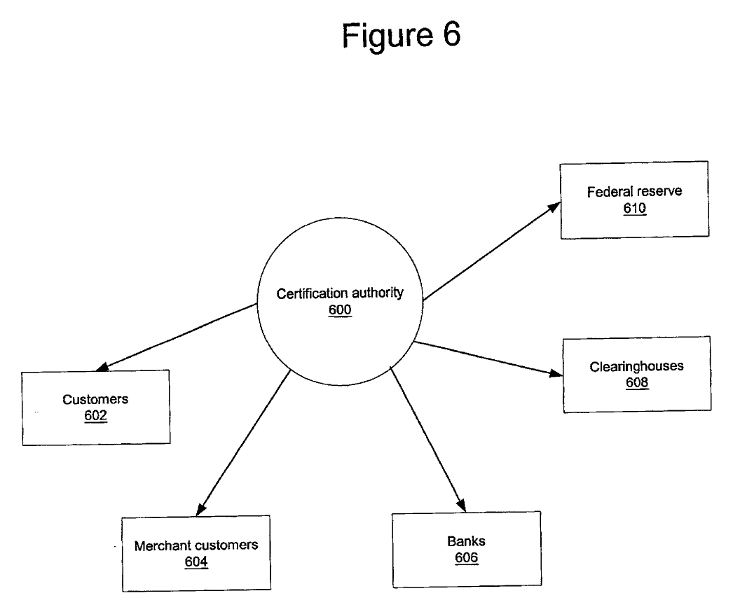

Turning next to FIG. 6, a diagram illustrating a certificate system is depicted in accordance with a preferred embodiment of the present invention. To provide for security in transactions between various parties involved in processing checks, the present invention uses certification authority 600 to provide certificates to specific parties, such as customers 602, merchant customers 604, banks 606, clearinghouses 608, and Federal Reserve 610. A certificate is a digital equivalent of an ID card used in conjunction with a public key encryption system. Certificates are issued by trusted third parties known as certification authorities (CAs) such as VeriSign, Inc., Mountain View, CA, (www.verisign.com), after verifying that a public key belongs to a certain owner. The certification process varies depending on the CA and the level of certification. A driver's license, notarization and fingerprints are examples of documentation that may be required.

The certificate is actually the owner's public key that has been digitally signed by the CA. The digital certificate is sent along with an encrypted message to verify that the sender is truly the entity identifying itself in the transmission. The recipient uses the public key of the CA, which is widely publicized, to decrypt the sender's public key attached to the message. Then the sender's public key is used to decrypt the actual message. There are other possible authorization and authentication processes known to those of ordinary skill in the art.

Further, in the preferred embodiment the processes of the present invention also transmit using an encryption system to provide for a secure transmission of information, such as images of checks. For example, Secure Sockets Layer (SSL) is an example of a security protocol on the Internet that may be used to provide for secure transmissions. When an SSL session is started, the server sends its public key to the browser, which the browser uses to send a randomly-generated secret key back to the server in order to have a secret key exchange for that session.

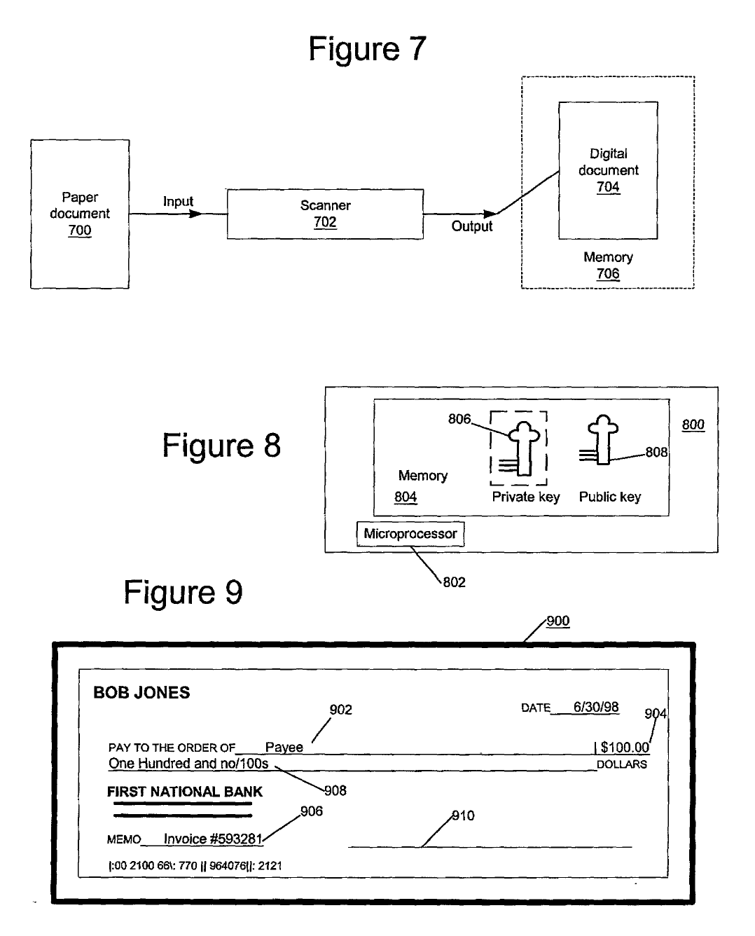

Turning next to FIG. 7, a diagram illustrating data flow in creating a check image is depicted in accordance with a preferred embodiment of the present invention. Paper document 700 is input or placed into an ATM, such as ATM 300 through input slot 304 in FIG. 3. In this example, paper document 700 is a check. Scanner 702 scans both sides of paper document 700. In this manner, endorsements as well as signature and amount information from the front of the check may be obtained. Digital document 704 is generated by scanner 702 and stored in memory 706 for further processing. Optical character recognition processes (OCR) may be initiated to process digital document 704 to generate information used in creating a markup language representation of paper document 700. In these examples, this markup language representation form an electronic check.

With reference now to FIG. 8, a diagram of a smart card, which may be used to create an electronic check, is depicted in accordance with a preferred embodiment of the present invention. Smart card 800 is a credit card with microprocessor 802 and memory 804, and is used for identification or financial transactions. When inserted into a reader, such as, for example, through slot 302 in ATM 300 in FIG. 3, smart card 800 transfers data to and from ATM 300. In these examples, smart card 800 contains private key 806 and public key 808 within memory 804. The private key is used for digital signing of checks in these examples.

More precisely, the private key is used in the process of applying a digital signature to an electronic check or an electronic document. Applying a digital signature by using hashing operations in a private key is well known to those of ordinary skill in the art. However, for other activities, the public key of an individual is also typically stored in a smart card and this is how smart card 800 has been depicted. Note that smart card 800 is depicted for the purposes of the preferred embodiment of the present invention. Other cards, such as credit cards may also be used. Popular usage does not normally refer to credit cards as smart cards. However, technically speaking even credit cards are a type of smart card and are governed by internationally accepted, appropriate smart card standards. Hence, the preferred embodiment of the present invention is illustrated through a generic smart card in preference to a conventional credit card or an ATM card.

Smart card 800 is more secure than a magnetic stripe card and can be programmed to self-destruct if the wrong password is entered too many times. As a financial transaction card, smart card 800 can be loaded with digital money and used like a travelers check, except that variable amounts of money can be spent until the balance is zero.

Turning now to FIG. 9, a diagram of a check presented on a display for completion is depicted in accordance with a preferred embodiment of the present invention. Check 900 is an example of a check, which may be presented to a user on a display, such as display 312 in ATM 300 in FIG. 3. Check 900 is presented to the user after verification of the user's authority to generate a check.

In the depicted examples, the verification is made by an insertion of a smart card in an ATM, such as ATM 300 in FIG. 3 along with entry of a correct password or PIN. The user may enter information into payee field 902, amount field 904, and memo field 906. Entry of an amount in amount field 904 results in amount field 908 being auto filled for the user. In this example, payee field 902 and amount field 904 are required fields that must be filled in for check 900 to be complete. Memo field 906 is an optional field, which may be left blank. In the depicted examples, a digital signature is used to complete the check and may be provided through the smart card. Depending on the implementation, the user may actually sign field 9010 using a stylus if the display includes a touch screen to accept such data.

When the user affirms that the check is complete and should be sent, the check may then be routed to the payee or to some other party in the form of an electronic check. The electronic check is in the form of a markup language document as described above. More specifically, financial services markup language (FSML) is an example of a markup language, which may be used to generate electronic checks. Additionally, check 900 may be sent as an image for processing within a financial system without requiring generation of an electronic check.

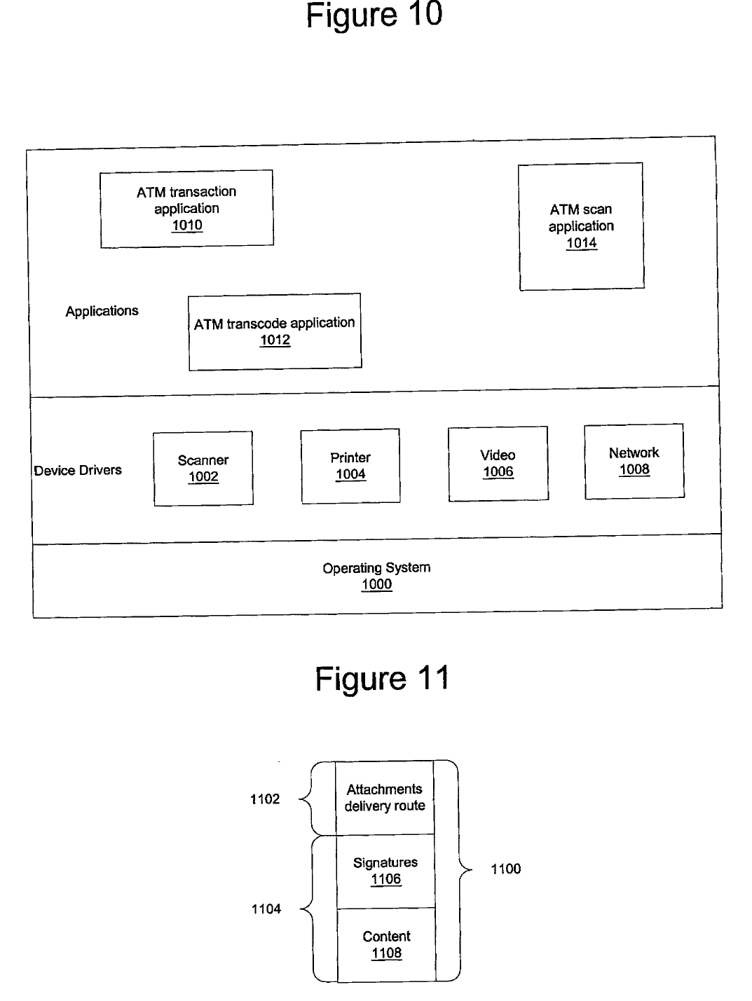

Turning next to FIG. 10, a diagram illustrating software components in an ATM is depicted in accordance with a preferred embodiment of the present invention. In this example, the software components in an ATM include operating system 1000, scanner device driver 1002, printer device driver 1004, video device driver 1006, network device driver 1008, ATM transaction application 1010, ATM transcode application 1012, and ATM scan application 1014.

The device drivers provide the components needed to operate devices within an ATM. These device drivers are used by ATM transaction application 1010, ATM transcode application 1012, and ATM scan application 1014 to perform various input/output functions.

ATM transaction application 1010 provides a process for various transactions by a user. Cash withdrawals, balance inquiries, fund transfers, and deposits are examples of transactions that may be handled through ATM transaction application 1010. Additionally, ATM transaction application 1010 handles the transmission and receipt of information to and from various financial institutions. When a check is deposited, ATM scan application 1014 is initiated to create an image of the check. In the depicted examples, the image is of both sides of the check. Additionally, ATM scan application 1014 also will include optical character recognition processes to obtain data for use in creating an electronic check. This data is used by ATM transcode application 1012 to generate a markup language representation of the check.

In these examples, the markup language may be financial services markup language (FSML) and signed document markup language (SDML). FSML is used to implement electronic checks and other secure financial documents. FSML defines a method to structure documents into blocks of tagged content. Unlike HTML, which uses tags to inform processors about how to display content, FSML uses tags to inform processors about how to use the document content in financial applications. The FSML content blocks in an FSML document can be cryptographically sealed and signed in any combination needed by business applications. Document processors may also remove blocks without invalidating the signatures on the remaining blocks. They may combine signed documents and then sign blocks contained in the combined documents. Signatures are themselves structured as FSML blocks, as are the X.509 certificates needed by downstream processors to verify the signatures. Thus signatures and certificates become part of the FSML document, so they can be verified and countersigned by later signers.

SDML is designed to tag the individual text items making up a document, group the text items into document parts which can have business meaning and can be signed individually or together, allow document parts to be added and deleted without invalidating previous signatures, and allow signing, cosigning, endorsing, co-endorsing, and witnessing operations on documents and document parts. The signatures become part of the SDML document and can be verified by subsequent recipients as the document travels through the business process. SDML does not define encryption, since encryption is between each sender and receiver in the business process and can differ for each link depending on the transport used. SDML is the generic document structuring and signing part of the FSML.

In the depicted examples, the markup language document forms an electronic check. Depending on the implementation, the electronic check also may include the image of the check.

Turning next to FIG. 11 an illustration of a message sent from an ATM to a financial institution is depicted in accordance with a preferred embodiment of the present invention. Message 1100 is an example of a message that may be sent from an ATM to a financial institution. For example, an electronic check generated at an ATM, such as ATM 108 in server 104 in FIG. 1 for processing. The electronic check may be sent within message 1100.

Message 1100 includes header 1102 and body 1104. Header 1102 may include information, such as an identification of attachments and a delivery route for the message. Body 1104 may include signatures 1106 as well as content 1108. Signature 1106 may be obtained from scanning of the check. Content 1108 may contain the image of the check and/or an electronic check. The electronic check may be a document created using FSML and SDML.

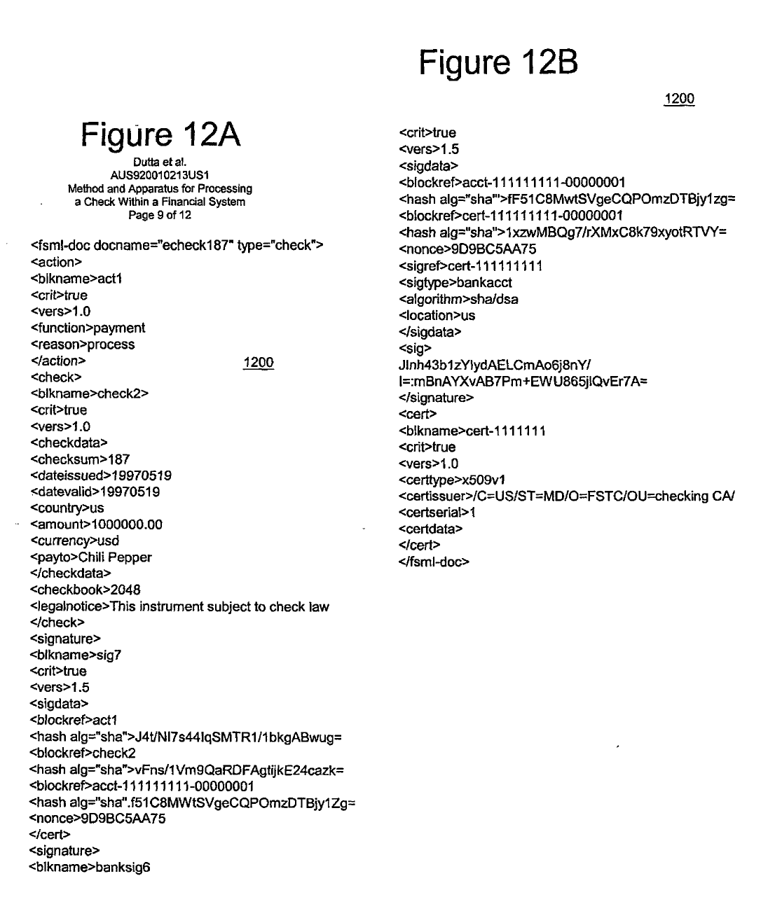

Referring now to FIGS. 12A-12B, a diagram of an electronic check is depicted in accordance with a preferred embodiment of the present invention. Electronic check 1200 is in the form of a financial services markup language (FSML) document. This example illustrates some fields that may be found within an electronic check. In this example, electronic check 1200 does not illustrate the actual certificate of data used in the document. Electronic check 1200 is an example of an electronic check, which may be created by transcode application 1012 in FIG. 10 in response to scanning a check or creating a check, such as check 900 in FIG. 9.

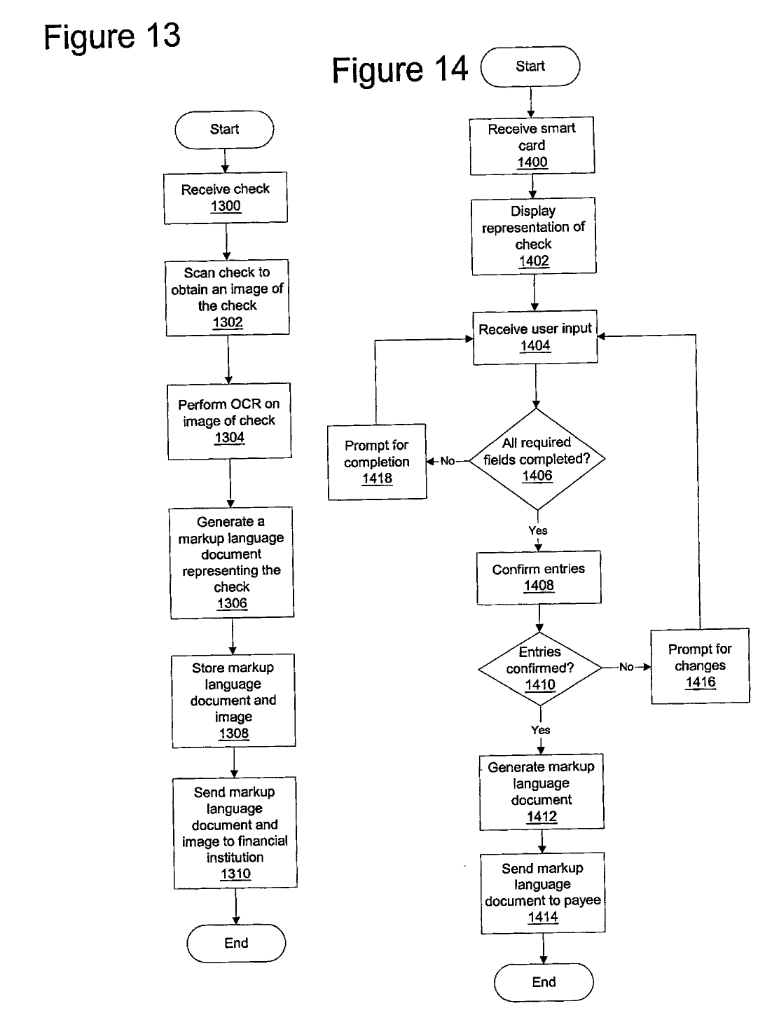

Turning next to FIG. 13, a flowchart of a process used for processing a check at an ATM is depicted in accordance with a preferred embodiment of the present invention. The process illustrated in FIG. 13 may be implemented within ATM scan application 1014 and ATM transcode application 1012 in FIG. 10.

The process begins by receiving a check (step 1300). Next, the check is scanned to obtain an image of the check (step 1302). In these examples, both sides of the check are scanned. Additionally, this scanning step also may include reading magnetic ink data on the check, which may contain a bank identification number and a checking account number. Optical character recognition (OCR) is performed on the image of the check to generate data for use in creating an electronic check (step 1304). Checks may be designed to facilitate authentication by scanning. For example, ultraviolet inks may be used.

Then, a markup language document is generated representing the check (step 1306). This markup language document forms an electronic check in this example. The markup language document and image are stored (step 1308). Thereafter, the markup language document and the image are sent to the financial institution (step 1310) with the process terminating thereafter. The markup language document and image are sent to the financial institution through a communications link, such as one provided by network 102 in FIG. 1.

In this manner, the check deposited by the ATM user can be processed without requiring further physical handling to transfer funds to the ATM user's account. Thus, the process used for transferring funds between account may be streamlined through the creation of electronic checks from physical checks at an ATM.

Turning next to FIG. 14, a flowchart of a process used for creating an electronic check is depicted in accordance with a preferred embodiment of the present invention. The process illustrated in FIG. 14 may be implemented in a set of computer instructions for use in applications, such as ATM transaction application 1010 and ATM transcode application 1012 in FIG. 10.

The process begins by receiving a smart card, such as smart card 800 in FIG. 8 from a user (step 1400). Next, a representation of a check, such as check 900 in FIG. 9 is displayed (step 1402). The user is the payor in this example. User input is then received (step 1404). This user input includes entry of information into fields, such as an amount for the check, a payee, and a memo. A determination is then made as to whether all required fields are completed (step 1406).

If all required fields are completed, the entries are confirmed (step 1408). This confirmation allows the user one last chance to make changes or cancel the check before the transaction is initiated. Next, a determination is then made as to whether the entries are confirmed (step 1410). If confirmed, a markup language document is generated (step 1412). This document forms the electronic check. The markup language document is then sent to a the payee, the payee's financial institution, or some third party authorized to receive checks for the payee (step 1414) with the process terminating thereafter.

With reference again to step 1410, if the entries are not confirmed, the user is prompted for changes (step 1416) and the process returns to step 1404 as described above. Turning back to step 1406, if all required fields are not completed, then the user is prompted for completion (step 1418) and the process returns to step 1404.

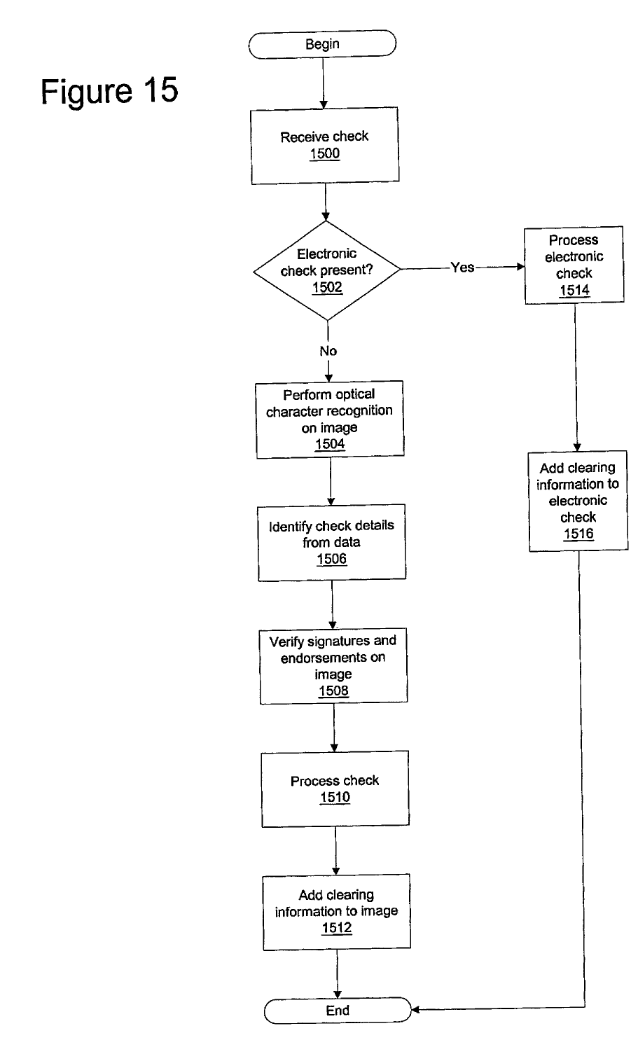

Turning next to FIG. 15, a flowchart of a process used for processing a check within a financial system is depicted in accordance with a preferred embodiment of the present invention. The process illustrated in FIG. 15 may be implemented in a financial institution, such as merchant bank 508, regional clearinghouse 510, or bank 512 in FIG. 5.

The process begins by receiving a check (step 1500). A determination is made as to whether the check is an electronic check (step 1502). In some cases, an electronic check in the form of a FSML document may be received in addition to or in place of an image of the check. If the check is not an electronic check, an optical character recognition on the image is performed (step 1504). Then, the check details from data are identified (step 1506). For example, identification of the payee, payor, amount of the check, routing information, and signature fields may be identified for use in processing the check. Signatures and endorsements on the image are verified (step 1508). These signatures and endorsements may be identified by comparing the signatures and endorsements found in the image with those retained on signature cards or databases. Next, the check is processed (step 1510). Clearing information is added to the image (step 1512) with the process terminating thereafter. This clearing information may include, for example, an identification of the financial institution processing the check as well as a name, address, and transaction number.

With reference again to step 1502, if the check is an electronic check, the electronic check is processed (step 1514). Then, clearing information is added to the electronic check (step 1516) with the process terminating thereafter. Other information showing the type of transactions and the date of transaction also may be included on either or both of the electronic check or the image of the check.

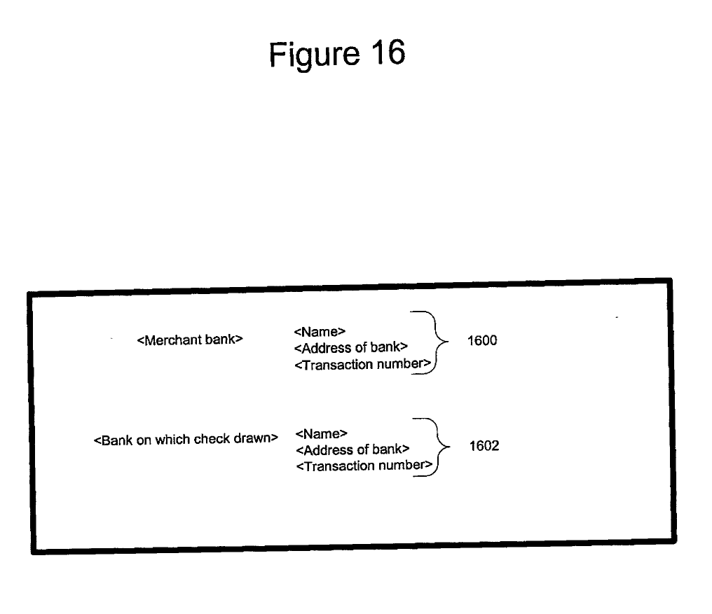

With reference to FIG. 16, a diagram illustrating endorsements that may be used by financial institutions during the clearing process of a check are depicted in accordance with a preferred embodiment of the present invention. In this example, endorsements 1600 and 1602 are examples of endorsements added or associated with an electronic check. These endorsements are in a markup language, such as in FSML format. Alternatively, an image of a conventional endorsement may be added to an image of the check, depending on the particular implementation.

This mechanism provides for faster and more efficient processing of checks within a financial system. By generating an image of a check and a markup language document or electronic check, physical handling of the check is not needed after a user enters or creates the check at an ATM. All of this information may be transmitted to the financial institution electronically. If a physical check was deposited, this check may be retrieved at a later time for storage, return, or disposal. Retrieval of the physical check itself is not required to facilitate the transaction, thus saving time. Additionally, inputting information by employees of the financial institution is not needed. In some cases, the image may be used to verify that the information is correct or to input missing information in case the OCR process is unable to properly identify required information.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the illustrations above describe processing of an image received from an ATM. Additionally, the smart card may be replaced by a regular credit card or an ATM card with some loss in functionality. The mechanism also may apply to physical checks received at a financial institution. In this case, the financial institution scans the checks to create images. From that point on, the processing of the check only requires the image and eliminates any further physical handling of the check with respect to processing of the check to transfer funds. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a network data processing system for processing a check, the method comprising:
receiving a check image of the check from an automatic teller machine, wherein the check image is generated by a scanner in the automatic teller machine;
performing optical character recognition on the check image to generate data; and
performing check clearing processes using the check image and the data.

2. The method of claim 1 further comprising:
sending the check image to an issuer of the check.

3. The method of claim 2, wherein the sending step comprises:
printing the check image on paper to form a paper copy of the check; and
sending the paper copy of the check to the issuer.

4. The method of claim 1, wherein the check image includes a front side and a back side of the check.

5. The method of claim 1, wherein the step of performing check clearing processes includes:
adding overlay prints showing who is clearing the check.

6. The method of claim 1, wherein the check image is received from an automatic teller machine through a communications link.

7. The method of claim 1, wherein the data processing system is located at a bank.

8. The method of claim 1, wherein the data processing system is an automatic teller machine.

9. A data processing system for processing a check, the data processing system comprising:
receiving means for receiving a check image of the check from an automatic teller machine, wherein the check image is generated by a scanner in the automatic teller machine;
first performing means for performing optical character recognition on the check image to generate data; and
second performing means for performing check clearing processes using the check image and the data.

10. The data processing system of claim 9 further comprising:
sending means for sending the check image to an issuer of the check.

11. The data processing system of claim 10, wherein the sending means comprises:
means for printing the check image on paper to form a paper copy of the check; and
means for sending the paper copy of the check to the issuer.

12. The data processing system of claim 9, wherein the check image includes a front side and a back side of the check.

13. The data processing system of claim 9, wherein the means of performing check clearing processes includes:
means for adding overlay prints showing who is clearing the check.

14. The data processing system of claim 9, wherein the check image is received from an automatic teller machine through a communications link.

15. The data processing system of claim 9, wherein the data processing system is located at a bank.

16. The data processing system of claim 9, wherein the data processing system is an automatic teller machine.

17. A computer program product in a computer readable medium for processing a check, the computer program product comprising:
first instructions for receiving a check image of the check from an automatic teller machine, wherein the check image is generated by a scanner in the automatic teller machine;
second instructions for performing optical character recognition on the check image to generate data; and
third instructions for performing check clearing processes using the check image and the data.

18. The computer program product of claim 17 further comprising:
fourth instructions for sending the check image to an issuer of the check.

19. The computer program product of claim 18, wherein the second instructions for sending comprises:
first sub-instructions for printing the check image on paper to form a paper copy of the check; and
second sub-instructions for sending the paper copy of the check to the issuer.

20. The computer program product of claim 17, wherein the check image includes a front side and a back side of the check.

21. The computer program product of claim 17, wherein the third instruction of performing check clearing processes includes:
first sub-instructions for adding overlay prints showing who is clearing the check.

22. The computer program product of claim 17, wherein the check image is received from an automatic teller machine through a communications link.

23. The computer program product of claim 17, wherein the data processing system is located at a bank.

24. The computer program product of claim 17, wherein the data processing system is an automatic teller machine.
